(19) United States
(12) Patent Application Publication
(10) Pub. No.: US 2017/0186046 A1
(43) Pub. Date: Jun. 29, 2017

(54) CONTROL METHOD FOR INFORMATION PROCESSING DEVICE, INFORMATION PROCESSING DEVICE, AND CONTROL PROGRAM

(71) Applicant: LINE Corporation, Tokyo (JP)

(72) Inventors: Hideyuki KAKIUCHI, Tokyo (JP); Kenichi SUGIMOTO, Tokyo (JP)

(21) Appl. No.: 15/081,687

(22) Filed: Mar. 25, 2016

(30) Foreign Application Priority Data
Dec. 24, 2015 (JP) 2015-250846

(51) Int. Cl. G06Q 30/02

(52) U.S. Cl. CPC G06Q 30/0272

(57) ABSTRACT

An information processing device is to be connected to a user terminal through an electric communication network, by a predetermined application which is installed in advance in the user terminal being started, if the user terminal receives a signal transmitted from an information transmitting terminal, acquires a predetermined type of terminal information for determining whether or not the user terminal includes preparation to receive advertising information corresponding to the signal transmitted from the information transmitting terminal, in addition to the installation of the predetermined application in the user terminal, determines whether or not the terminal information includes preparation to receive advertising information, and transmits the advertising information to the user terminal which transmits the terminal information which is determined to include preparation to receive the advertising information.

### CROSS-REFERENCE TO RELATED APPLICATION

This application claims the benefit of Japanese Patent Application No. 2015-250846, filed on Dec. 24, 2015, in the Japanese Patent Office, the disclosure of which is incorporated herein in its entirety by reference.

### BACKGROUND OF THE INVENTION

Field of the Invention

The present invention relates to a control method for an information processing device, an information processing device, and a control program, and particularly, relates to a control method for an information processing device, an information processing device, and a control program, in which the information processing device is to be connected to a user terminal through an electric communication network, by a predetermined application, which is installed in advance in the user terminal, being started if the user terminal receives a signal transmitted from an information transmitting terminal.

Background Art

In recent years, as the applications of a mobile terminal such as a smart phone (hereinafter, referred to as “user terminal”) have become more diverse, various services have become widespread. For example, the user terminal is on standby for a signal transmitted from an information transmitting terminal, such as a beacon that is provided in a store or the like, in the background, and starts the application, if the user terminal is within a predetermined distance and receives a signal.

Thus, the user terminal displays advertising information such as store information and product information, related to the received signal, on the display screen. The user checks the advertising information, and enters the store to receive the service to be provided.

In this manner, if the short-range wireless communication scheme such as a beacon is used, since a signal is received when the owner (user) who owns the user terminal including the application installed therein approaches the store or the like, it is possible to easily attract the customer to the store.

Meanwhile, a technology has also been proposed in which if the strength of the signal that the user terminal has received is a predetermined threshold or more, the user terminal is allowed to execute a certain action other than displaying an advertisement, such as making a friend registration or changing the brightness of the user terminal (for example, see Japanese Unexamined Patent Application Publication No. 2012-178747, and Japanese Unexamined Patent Application Publication No. 2010-109947)

### SUMMARY OF THE INVENTION

However, since the information transmitting terminal of a short-range wireless scheme, such as a beacon, is configured to unilaterally transmit signals, when a user terminal including an application installed therein approaches a coverage area, the user terminal unavoidably executes a certain operation.

Thus, in the service described above, since the reception of a signal is assumed to be wanted only by installing the application, the user receives the advertising information of a store or the like to which the user has not made a registration, only by the user passing through the nearby beacon.

This makes the user feel uncomfortable, as if the action is being monitored, and this does not attract the user but rather there is a possibility that the user feels disgust, because advertising information is displayed even though a product is not wanted to be purchased.

Thus, since the service has an improved effect in conveniently attracting and securing customers, but has a reverse effect of being likely to give discomfort and a feeling of disgust, the above service is not necessarily considered as a very convenient service.

Thus, the present invention is contrived in view of the above problem, and an object thereof is to provide a control method for an information processing device, an information processing device, and a control program, which are capable of improving the convenience of a service, while reducing a possibility of giving discomfort and a feeling of dislike, by determining whether or not the user wants the display of advertising information or does not want the display thereof based on a predetermined condition, in addition to the installation of the application.

According to an aspect of the present invention, there is provided a control method for an information processing device which is to be connected to a user terminal through an electric communication network, by a predetermined application which is installed in advance in the user terminal being started, if the user terminal receives a signal transmitted from an information transmitting terminal, the control method including: acquiring a predetermined type of terminal information for determining whether or not the user terminal includes preparation to receive advertising information corresponding to the signal transmitted from the information transmitting terminal, in addition to the installation of the predetermined application in the user terminal; determining whether or not the terminal information includes preparation to receive advertising information; and transmitting the advertising information to the user terminal which transmits the terminal information which is determined to include preparation to receive the advertising information in the determining.

In the control method for an information processing device according to the aspect of the present invention, the terminal information may include time information and signal reception strength information when the user terminal receives the signal transmitted from the information transmitting terminal, the determining may further include determining whether or not the time information is within a predetermined time, when the terminal information is acquired from a plurality of the user terminals, and specifying the user terminal having the highest reception strength level of the reception strength information, among all of the user terminals for which the time information is determined to be within the predetermined time in the terminal reception time determining, and in the advertising information transmitting, the advertising information may be transmitted to the user terminal that is specified in the terminal specifying.

In the control method for an information processing device according to the aspect of the present invention, the terminal information may include terminal state information for specifying whether or not the user terminal when receiving the signal transmitted from the information transmitting terminal is in a predetermined reception acceptable state due to an action of a user for preparation to receive the advertising information, the determining may further include specifying whether or not the terminal state information is in a predetermined reception acceptable state when the terminal information is acquired from the user terminal, and in the advertising information transmitting, the advertising information may be transmitted to the user terminal for which it is specified that the terminal state information is in a predetermined reception acceptable state in the terminal state specifying.

In the control method for an information processing device according to the aspect of the present invention, the terminal information may include time information and signal reception strength information when the user terminal receives the signal transmitted from the information transmitting terminal, and terminal state information for specifying whether or not the user terminal when receiving the signal transmitted from the information transmitting terminal is in a predetermined reception acceptable state due to an action of a user for the preparation to receive the advertising information, the determining may further include determining whether or not the time information is within a predetermined time, when the terminal information is acquired from a plurality of the user terminals, specifying the user terminals in descending order of the reception strength level of the reception strength information, among all of the user terminals for which the time information is determined to be within a predetermined time in the terminal reception time determining, and specifying whether or not the terminal state information is in a predetermined reception acceptable state, in descending order of the reception strength level of the reception strength information that is specified in the terminal specifying, and in the advertising information transmitting, the advertising information may be transmitted to the user terminal for which it is specified that the terminal state information is in a predetermined reception acceptable state in the terminal state specifying.

In the control method for an information processing device according to the aspect of the present invention, the terminal information may include function information indicating that a message display function is included in the predetermined application which is installed in the user terminal, and relationship information for starting the message display function in association with the signal transmitted from the information transmitting terminal, and the determining may include determining whether or not the relationship information is included, when the terminal information is acquired from the user terminal, and in the advertising information transmitting, if it is determined that the relationship information is included in the terminal information in the mutual friendship determining, the advertising information may be transmitted to the user terminal so as to start the message display function.

In the control method for an information processing device according to the aspect of the present invention, the predetermined application including a message display function may be installed in the user terminal, the terminal information may include time information and signal reception strength information when the user terminal receives the signal transmitted from the information transmitting terminal, and relationship information for starting the message display function in association with the signal transmitted from the information transmitting terminal, the determining may further include determining whether or not the time information is within a predetermined time, when the terminal information is acquired from a plurality of the user terminals, specifying the user terminals in descending order of the reception strength level of the reception strength information, among all of the user terminals for which the time information is determined to be within a predetermined time in the terminal reception time determining, and determining whether or not the relationship information is included, in descending order of the reception strength level of the reception strength information which is specified in the terminal specifying, and in the advertising information transmitting, if it is determined that the relationship information is included in the terminal information in the mutual friendship determining, the advertising information may be transmitted to the user terminal so as to start the message display function.

In the control method for an information processing device according to the aspect of the present invention, a messaging application that is started in association with start-up of the predetermined application including a message display function may be installed in the user terminal, the terminal information may include terminal state information for specifying whether or not the user terminal when receiving the signal transmitted from the information transmitting terminal is in a predetermined reception acceptable state due to an action of the user for preparation to receive the advertising information, time information and signal reception strength information when the user terminal receives the signal transmitted from the information transmitting terminal, and relationship information for starting the message display function in association with the signal transmitted from the information transmitting terminal, the determining may further include specifying whether or not the terminal state information is in a predetermined reception acceptable state, when the terminal information is acquired from the user terminal, determining whether or not the time information that is acquired from the plurality of user terminals is within a predetermined time, in a case where there are a plurality of user terminals which are specified that the terminal state information is in a predetermined reception acceptable state in the terminal state specifying, specifying the user terminals in descending order of the reception strength level of the reception strength information, among all of the user terminals for which the time information is determined to be within a predetermined time in the terminal reception time determining, and determining whether or not the relationship information is included, in descending order of the reception strength level of the reception strength information which is specified in the terminal specifying, and in the advertising information transmitting, if it is determined that the relationship information is included in the terminal information in the mutual friendship determining, the advertising information may be transmitted to the user terminal so as to start the message display function.

In the control method for an information processing device according to the aspect of the present invention, the terminal information may include time information when the user terminal receives the signal transmitted from the information transmitting terminal, the determining may further include determining whether or not the same terminal information is acquired a plurality of times within a predetermined time, based on the time information, when a plurality of pieces of terminal information are acquired, and in the advertising information transmitting, the advertising information may be transmitted to the user terminal which transmits the same terminal information for which it is determined that the same terminal information is acquired a plurality of times within a predetermined time in the same terminal determining.

According to another aspect of the present invention, there is provided an information processing device which is to be connected to a user terminal through an electric communication network, by a predetermined application which is installed in advance in the user terminal being started, if the user terminal receives a signal transmitted from an information transmitting terminal, the information processing device including: a terminal information acquisition unit that acquires a predetermined type of terminal information for determining whether or not the user terminal includes a preparation to receive advertising information corresponding to the signal transmitted from the information transmitting terminal, in addition to the installation of the predetermined application in the user terminal; a determination unit that determines whether or not the terminal information includes preparation to receive advertising information; an advertising information transmission unit that transmits the advertising information to the user terminal which transmits the terminal information which is determined to include preparation to receive advertising information by the determination unit.

According to a still another aspect of the present invention, there is provided a non-transitory computer readable recording medium having a display program stored thereon, the program causing a computer which is to be connected to a user terminal through an electric communication network, the program causes the computer to realize the following functions of: acquiring a predetermined type of terminal information for determining whether or not the user terminal includes preparation to receive advertising information corresponding to the signal transmitted from the information transmitting terminal, in addition to the installation of the predetermined application in the user terminal; determining whether or not the terminal information includes preparation to receive advertising information; and transmitting the advertising information to the user terminal which transmits the terminal information which is determined to include preparation to receive advertising information in the determination function.

According to the present invention, in addition to the installation of an application, since whether the user is a user who wants display of advertising information or a user who does not want display thereof is determined based on a predetermined condition, it is possible to reduce a possibility of making the user feel discomfort and dislike, and improve the convenience of the service.

### BRIEF DESCRIPTION OF THE DRAWINGS

FIG. 1 is a system explanatory diagram illustrating an installation example of an information transmitting terminal to which an information processing device according to an embodiment of the present invention is applicable.

FIG. 2 is a system explanatory diagram illustrating an example of a service system configuration using the information processing device according to the embodiment of the present invention.

FIG. 3 is a sequence diagram illustrating a processing procedure by the information processing device according to the embodiment of the present invention.

FIGS. 4A and 4B illustrate advertising information display examples on a user terminal by the information processing device according to the embodiment of the present invention, FIG. 4A is an explanatory diagram of a display example of advertising information corresponding to a signal transmitted from the information transmitting terminal, and FIG. 4B is an explanatory diagram of a display example of a transition screen including other types of advertising information.

FIG. 5 is a flowchart illustrating a main routine by the information processing device according to the embodiment of the present invention.

FIG. 6 is a flowchart illustrating a settlement routine by the information processing device according to the embodiment of the present invention.

FIG. 7 is a flowchart illustrating a delivery routine by the information processing device according to the embodiment of the present invention.

FIG. 8 is a sequence diagram illustrating a processing procedure by the information processing device according to the embodiment of the present invention, in a case where the user terminal performs threshold determination.

FIG. 9 is a sequence diagram illustrating a processing procedure by the information processing device according to the embodiment of the present invention, in a case where the user terminal performs a passing or accommodating determination.

FIG. 10 is a sequence diagram illustrating a processing procedure by the information processing device according to the embodiment of the present invention, in a case where the user terminal performs a terminal state determination.

### DETAILED DESCRIPTION OF THE INVENTION

Hereinafter, an embodiment of an information processing device according to the present invention will be described with reference to the drawings.

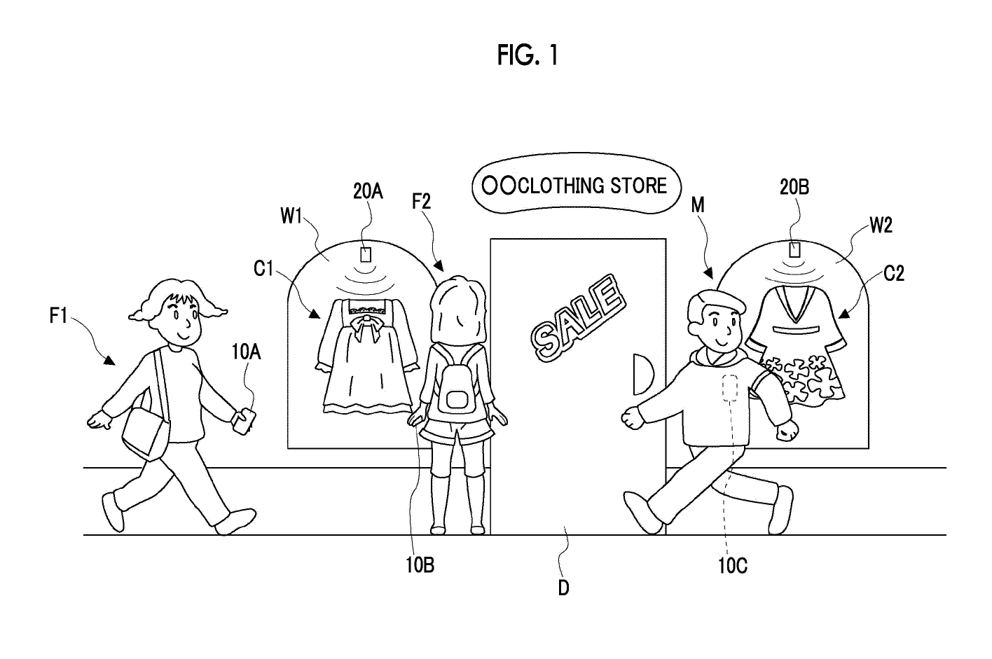

As illustrated in FIG. 1, it is assumed that there is a woman F2 who stops and views the product (for example, a tunic) C1 that is displayed in the window W1 of a store, in addition to a woman F1 and a man M who walk on the sidewalk outdoors.

In this case, it is assumed that the woman F1 and the woman F2 hold the user terminals 10A, 10B such as a smartphone in their hands, and the man M has the user terminal 10C such as a smart phone in the pocket of a garment. Incidentally, in the following description, it is assumed that the type or the like is disregarded for the user terminals 10A, 10B, 10C, and at least a predetermined application according to this embodiment is previously installed therein. Therefore, in a case where there is no particular need for distinction, a description will be made for a user terminal 10 having various communication functions or the like.

Meanwhile, information transmitting terminals 20A, 20B that transmit, for example, information including store information (hereinafter, referred to as “@ID”) and the ID corresponding to product information about products C1, C2 (hereinafter, referred to as “Product ID”) which are displayed in the windows W1, W2 on both sides of the door D for entrance are provided in the store, as a signal. In the following description, the store information and the product information are collectively referred to as advertising information. Further, the information transmitting terminal 20A, 20B will be described as information transmitting terminal 20, in a case where there is no need for distinction. In the present embodiment, although using a known beacon which is a short-range wireless communication scheme is used for the information transmitting terminal 20, for example, a radio frequency identifier (RFID) tag or the like may be used.

The specific apparatus of the user terminal 10 is not limited to smart phones which are illustrated, and for example, tablet terminals, notebook type personal computers, or other communication terminals may be used.

In this case, the predetermined application that is installed in the user terminal 10 realizes a message display function according to a chat system or the like, in addition to the predetermined application for receiving information that is transmitted from the information transmitting terminal 20 of a short-range wireless scheme such as a beacon according to the embodiment of the present invention. Further, the application that realizes the function of receiving the information that is transmitted from the information transmitting terminal 20 and the application that realizes the message display function according to a chat system may be separated.

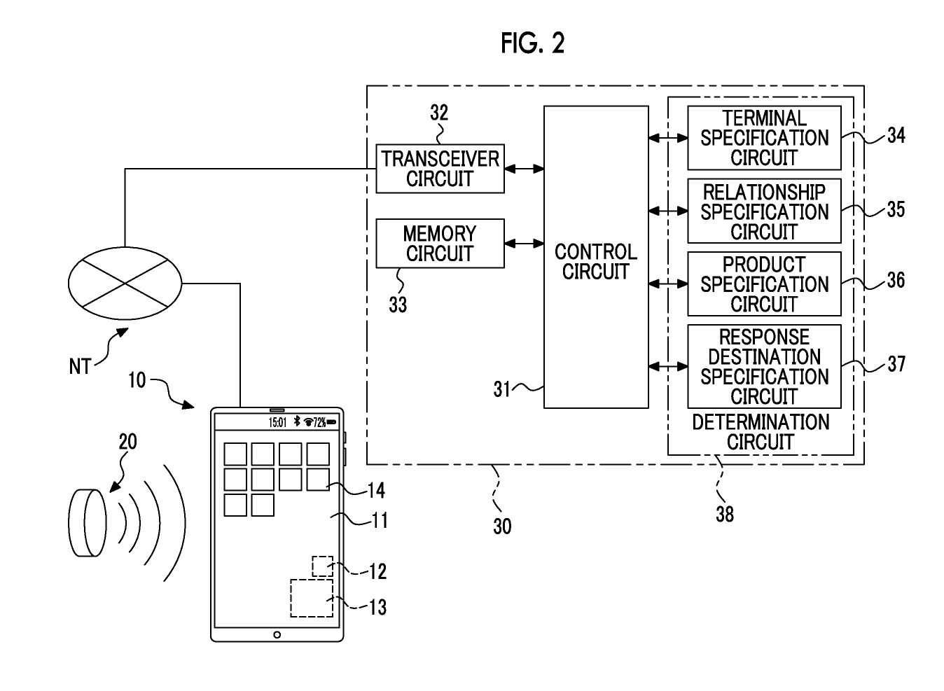

As illustrated in FIG. 2, the user terminal 10 includes a display screen 11 of a touch panel type which serves as an operation unit (an input unit), a memory circuit 12 for installing an application for calling and communication, in addition to the above-described predetermined application, and a control circuit 13 that performs a variety of functions in accordance with the application that is installed in the memory circuit 12. A plurality of icons 14 for starting the installed application are displayed on the display screen 11.

The user terminal 10 is configured to be able to receive the signal transmitted from the information transmitting terminal 20, and to be connected to the information processing device 30 through an electric communication network NT such as an Internet line. In this case, the information processing device 30 is configured to be connected to the user terminal 10 through an electric communication network, by a predetermined application which has been installed in advance in the user terminal 10 being started, if the user terminal 10 receives a signal transmitted from an information transmitting terminal 20.

A plurality of the information processing devices 30 may be used in a function manner. With respect to the information processing device 30, for example, a general-purpose personal computer or the like as a server can be used. The information processing device 30 includes a control circuit 31, a transceiver circuit 32 which enables the exchange of information with the user terminal 10 through the electric communication network NT, and a memory circuit 33 such as a hard disk drive (HDD) for installing the application including an operating system (OS) for operating the control circuit 31.

The control circuit 31 processes the application that is installed in the memory circuit 33. The control circuit 31 is an electronic circuit (CPU) which acts as a central processing device in the information processing device 30 which is a computer. Therefore, the control circuit 31 forms a computer, together with the memory circuit 33, and executes various types of digital processing, in other words, the functional processing according to the application.

The transceiver circuit 32 includes an interface circuit, and has a function of executing communication with the user terminal 10 (transmission and reception of various types of data, messages, and the like) through the electric communication network NT. In this case, communication may be executed in either a wired or wireless manner, and any communication protocol may be used therein insofar as mutual communication with the user terminal 10 can be executed. Here, the message is not limited to the text message, and includes images, audio, videos, stamps (digital stickers), and the like. The transceiver circuit 32 acquires a predetermined type of terminal information for determining whether or not the user terminal 10 includes preparation to receive advertising information corresponding to the signal transmitted from the information transmitting terminal 20, in addition to the installation of the predetermined application in the user terminal 10. Thus, the transceiver circuit 32 functions as a terminal information acquisition unit in the claims. In addition, the transceiver circuit 32 transmits the advertising information stored in the memory circuit 33 to the user terminal 10. Therefore, the transceiver circuit 32 functions as an advertising information transmission unit in the claims.

The memory circuit 33 stores in addition to various applications according to the present embodiment, customer information or the like including the product ID of each product, @ID containing the name, the position information, and the like of a store, and identification information for specifying the user terminal 10 (hereinafter, simply referred to as “MID”), in a database. The memory circuit 33 is a component that directly stores information, outside of a storage element in a broad sense, in other words, a storage device of an electronic calculator (computer), and may be a memory circuit such as a flip-flop utilizing the state of a circuit and a static volatile memory (RAM). With respect to the memory circuit 33, it is possible to use, for example, various recording media (memory circuits) with different functions and capacities such as a flash memory including a solid state drive (SSD) in addition to the above-described HDD.

Meanwhile, the control circuit 31 of the information processing device 30 according to the present embodiment determines whether or not terminal information includes preparation to receive advertising information, and transmits the advertising information from the transceiver circuit 32. Therefore, the control circuit 31 controls the terminal specification circuit 34, the relationship specification circuit 35, the product specification circuit 36, and the response destination specification circuit 37.

The terminal specification circuit 34 determines whether or not the terminal state information is in a predetermined reception acceptable state, when the terminal information is acquired from the user terminal 10. Therefore, the terminal specification circuit 34 performs the terminal state specifying in the claims. Furthermore, the terminal specification circuit 34 determines whether or not the time information that is acquired from the plurality of user terminals 10 is within a predetermined time, in a case where there are a plurality of user terminals 10 which are specified that the terminal state information is in a predetermined reception acceptable state. Therefore, the terminal specification circuit 34 performs the terminal reception time determining in the claims. In addition, the terminal specification circuit 34 specifies the user terminals 10 in descending order of the reception strength level of the reception strength information, among all of the user terminals 10 for which the time information is determined to be within a predetermined time, for a plurality of user terminals 10. Therefore, the terminal specification circuit 34 performs the terminal specifying in the claims.

The relationship specification circuit 35 determines whether or not the relationship information is included, in descending order of the reception strength level of the reception strength information which is specified. Therefore, the relationship specification circuit 35 performs the relationship determining in the claims.

The product specification circuit 36 generates advertising information including product photos and sales for stores, and the like, from the product ID and @ID included in the terminal information that is acquired from the user terminal 10 which is specified by the terminal specification circuit 34 and the relationship specification circuit 35, by referring to the database that is stored in the memory circuit 33, and transmits the MID and the advertising information of the specified user terminal 10, to the response destination specification circuit 37.

The response destination specification circuit 37 determines a relationship between the MID that is received from the product specification circuit 36 and the advertising information, and transmits the advertising information to the corresponding MID (user terminal 10), so as to start the message display function by a chat system. Therefore, the response destination specification circuit 37 performs the advertising information transmitting in the claims.

In addition, the terminal specification circuit 34, the relationship specification circuit 35, the product specification circuit 36, and the response destination specification circuit 37 function as the determination circuit 38 that determines whether or not the terminal information received from the user terminal 10 includes preparation to receive advertising information, in a single information processing device 30. Therefore, the determination circuit 38 functions as the determination unit in the claims.

In this case, the terminal specification circuit 34, the relationship specification circuit 35, the product specification circuit 36, and the response destination specification circuit 37 may be formed by a single information processing device 30, or may be formed by a plurality of information processing devices 30 that are connected through a network, independently from each other or in combination with each other.

In the following description, the terminal information that is transmitted from the user terminal 10 to the information processing device 30 through the electric communication network NT includes the product ID of the information transmitting terminal 20 and @ID, in addition to the identification information for specifying the user terminal 10 (hereinafter, simply referred to as “MID”). Further, the terminal information includes terminal state information for specifying whether or not the state of the user terminal 10 when the user terminal 10 receives the signal transmitted from the information transmitting terminal 20 is in a predetermined reception acceptable state due to the action of the user for preparation to receive the advertising information. Further, the terminal information includes time information (hereinafter, referred to as “timestamp”) and signal reception strength information when the user terminal 10 receives the signal transmitted from the information transmitting terminal 20. Further, the terminal information includes relationship information for starting the message display function by a chat system, in association with the signal transmitted from the information transmitting terminal 20.

The terminal state information includes, for example, a case indicating the user terminal 10 of which the user does not strongly allow the user terminal to be in the reception acceptable state by using the function which is provided in advance in the user terminal 10. Specifically, the user terminal 10 is the user terminal 10 of the user who wants to simply pass through the front of the store. Since the information processing device 30 specifies whether or not it is such a user terminal 10, it is possible to use the detection signal of an acceleration sensor that is used to acquire the current position information, as the function that the user terminal 10 already has, for the terminal state information. When detecting that the acceleration sensor is walking (the user terminal 10 is moving), it is possible to assume that the user does not strongly allow the user terminal to be in the reception acceptable state, based on the walking detection signal. On the contrary, when detecting that the acceleration sensor is stopped, it is possible to assume that the user strongly allows the user terminal to be in the reception acceptable state, based on the stop detection signal. Therefore, whether or not the user is walking or is stopping corresponds to “the action of the user for preparation to receive the advertising information” in the claims. In other words, “the action of the user” in the claims is not the action of the user of simply installing the predetermined application (or starting), but rather it is assumed that the intention or the will (preparation) of the user that the user wants or does not want the reception (display) of the advertising information is specified by the “action of the user” of walking or not.

In the same manner, in order to specify whether or not the user wants to simply pass through the front of the store, it is possible to use the detection signal of a brightness sensor for automatically detecting whether the user terminal 10 is on standby such as a standby mode or an energy saving mode, for the terminal state information, by using the function included in the user terminal 10. If the brightness sensor detects “being on standby”, it is possible to assume that the user does not strongly allow the user terminal to be in the reception acceptable state due to the standby detection signal. On the contrary, if the brightness sensor detects “being in use”, based on that other functions such as calling are not in use, it is possible to assume that the user strongly allows the user terminal to be in the reception acceptable state due to the use detection signal. Therefore, whether or not the user makes the user terminal 10 be on standby or be in use corresponds to “the action of the user for preparation to receive the advertising information” in the claims. In other words, “the action of the user” in the claims is not the action of the user of simply installing the predetermined application (or starting), but rather it is assumed that the intention or the will (preparation) of the user that the user wants or does not want the reception (display) of the advertising information is specified by the “action of the user” of putting the user terminal 10 in a pocket or holding it in their hand.

In addition, the signal reception strength information when the user terminal 10 receives the signal transmitted from the information transmitting terminal 20 may be included in the terminal state information. For example, the closer to the information transmitting terminal 20, the stronger the signal reception strength, even though it is received by the user terminal 10. Thus, as the received signal reception strength is stronger, it is assumed that the user strongly allows the user terminal to be in the reception acceptable state. Therefore, whether or not the signal reception strength information is a predetermined threshold or more can correspond to “the action of the user for preparation to receive the advertising information” in the claims. In other words, “the action of the user” in the claims is not the action of the user of simply installing the predetermined application (or starting), but rather it is assumed that the intention or the will (preparation) of the user that the user wants or does not want the reception (display) of the advertising information is specified by the “action of the user” of strongly approaching the information transmitting terminal 20.

Furthermore, application being-in-use information indicating whether or not the message display function according to the chat system or the like is in use (=being executed) can be included in the terminal state measurement. In addition, the application being-in-use information includes, for example, being-in-use of an electric communication network such as a phone function, and an e-mail function (including the Internet function) (including during a call, during transmission and reception, during an input of a character, or the like). Thus, while using the message display function, the call function, the e-mail function, and the Internet function, it can be assumed that the user does not strongly allow the user terminal to be in the reception acceptable state. However, in a case where an interrupt is set in these functions, it can be assumed that the user strongly allows the user terminal to be in the reception acceptable state. Therefore, whether or not these functions are in use corresponds to “the action of the user for preparation to receive the advertising information” in the claims. In other words, “the action of the user” in the claims is not the action of the user of simply installing the predetermined application (or starting), but rather it is assumed that the intention or the will (preparation) of the user that the user wants or does not want the reception (display) of the advertising information is specified by the “action of the user” of using a communication function or not. On the contrary, in a case of using the message function, it may be assumed that the user wants to strongly receive publication information.

The relationship information means whether or not at least the user terminal registers as “friend” for the message display function by the chat system or the like. Incidentally, the method of “friend” registration is not particularly limited, and it is possible to determine by the information processing device 30, for example, by the user following @ID.

Next, the flows of the operation of the determination circuit 38, and the exchange of a message or the like between the determination circuit 38 and the user terminal 10 will be described. In addition, in the following description, a description will be made of a case where the terminal specification circuit 34, the relationship specification circuit 35, the product specification circuit 36, and the response destination specification circuit 37 are processed by three different information processing devices 30 which are connected through a network.

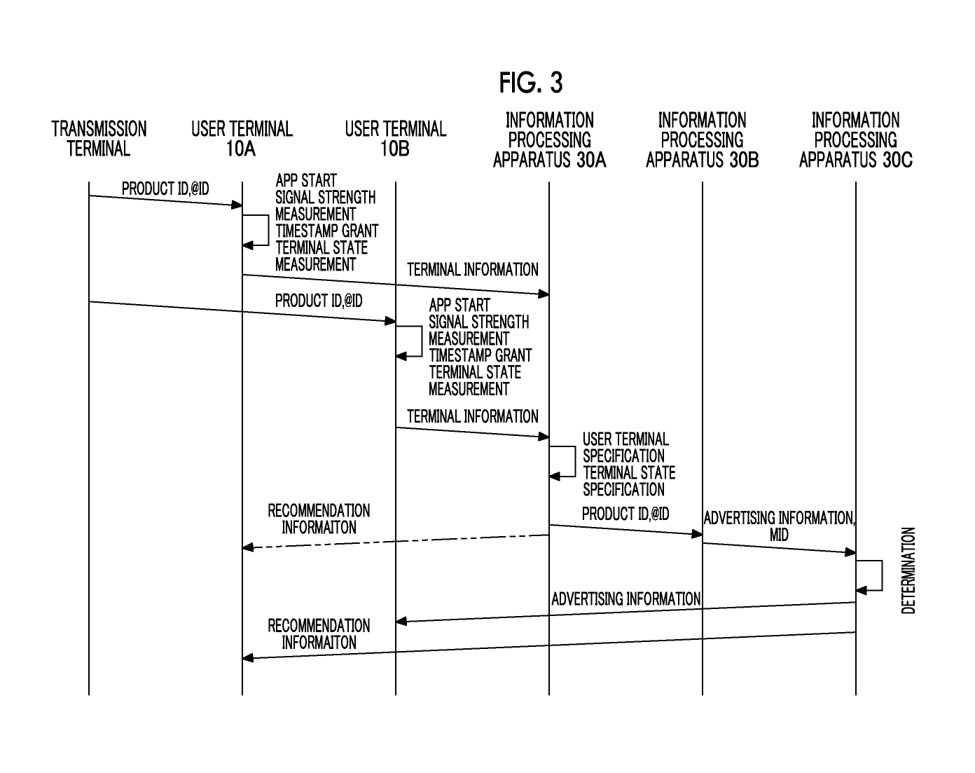

Specifically, it is assumed that the information processing device 30A illustrated in FIG. 3 includes, for example, a terminal specification circuit 34 and a relationship specification circuit 35 as a beacon response server function.

Further, it is assumed that the information processing device 30B includes, for example, a product specification circuit 36 as a product management server function.

Furthermore, the information processing device 30C includes, for example, a response destination specification circuit 37 as a talk server function. In addition, after determining a user terminal 10 which is to display the advertising information, the talk server function of the response destination specification circuit 37 displays a chat screen by the message display function on the display screen 11 of the target user terminal 10, and displays the advertising information, or the like corresponding to the display form of the chat screen. Therefore, the transceiver circuit 32 transmits data regarding the advertising information which is superimposed on the chat data by the message display function, to the target user terminal 10.

As illustrated in FIG. 3, the information transmitting terminal 20 transmits a signal about information including the product ID and @ID, for a predetermined time, at all times or with a predetermined interval. Thus, since the user terminal 10, for example, the user terminal 10A owned by the woman F1 (“user terminal 10A” in FIG. 3) waits for the signal in the background, a predetermined application is started, and granting of the strength level information regarding the reception strength of the received signal, a timestamp indicating reception time, and the terminal state measurement are performed.

Here, the terminal state measurement includes, for example, determination as to whether the user is walking or is stopping, as to whether the terminal is on standby or is in use, or the like.

A case where as in the woman F1 and the man M illustrated in FIG. 1, at least one of walking and being on standby is an example of a condition for determining that terminal users do not want the display of the advertising information, by the determination. Meanwhile, a case where the user terminal 10 is stopped, such as viewing the product C1 which is exhibited in the window W1, as in the woman F2 illustrated in FIG. 1, is an example of a condition for determining the user of the terminal that allows the display of the advertising information.

Here, the user terminal 10A, that the woman F1 holds in their hand while walking in front of the store, transmits the product ID and @ID, and the terminal information including respective pieces of information regarding the application grant, the signal strength measurement result, the timestamp grant, the terminal state measurement, and MID, to the information processing device 30A. Incidentally, since the user terminal 10C that the man M accommodates in their pocket is on standby that is described above, and is moving (walking), as a result, similar to the woman F1, the display of the advertising information is not strongly allowed, and here, it is assumed that the description regarding the woman F1 is used.

In the same manner, it is assumed that the woman F2 is passing by the front of the store, or is stopped in front of the window W1 at approximately the same timing. Since the woman F2 is in a state of holding (is using) the user terminal 10B (“user terminal 10B” in FIG. 3) in their hand, the user terminal 10B is on standby for the signal reception in the background. Thus, a predetermined application is started, and granting of the strength level information regarding the reception strength of the received signal, and a timestamp indicating reception time, and the terminal state measurement are performed.

Therefore, with respect to the user terminal 10B, in a timing shifted from that of the user terminal 10A, the product ID and @ID, and the terminal information including respective pieces of information regarding the application start, the signal strength measurement result, the timestamp grant, the terminal state measurement, and MID are transmitted to the information processing device 30A.

In a case of acquiring terminal information from a plurality of user terminals 10A, 10B, the information processing device 30A specifies the user terminals 10A, 10B based on the terminal information, and determines whether or not the user terminals 10A, 10B are in a state of allowing the display of the advertising information including the terminal state information. Here, the information processing device 30A determines that the user terminal 10A owned by the woman F1 is in a state of not allowing the advertising display, and determines that the user terminal 10B owned by the woman F2 is in a state of allowing the advertising display. The information processing device 30A transmits, at least, the product ID, @ID, and the MID of the user terminal 10B in association with each other, to the information processing device 30B.

The information processing device 30B transmits the advertising information which is a reference result and the MID to the information processing device 30C, from the information in which the product ID and @ID and the MID of the user terminal 10B are associated, which are received from the information processing device A, by referring to the database about the stock of the product in the store. Thus, the information processing device 30B can refer to the database as to whether or not there is stock in other stores of the chain and warehouses, and transmit the advertising information which is converted into the retail price or the like for the store including the information transmitting terminal 20 installed therein, to the information processing device 30C.

The information processing device 30C specifies the user terminal 10B by associating the advertising information that is received from the information processing device 30B with MID, develops (data conversion, or the like) it into the advertising information of a chat format, and transmits the advertising information to the user terminal 10B.

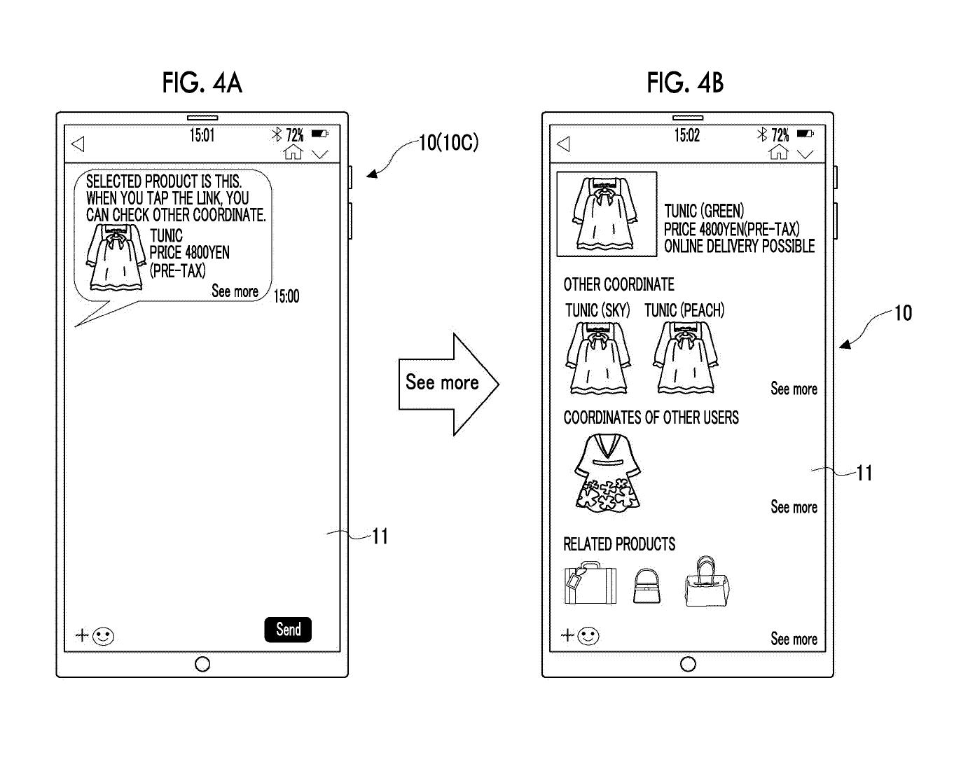

Thus, the advertising information is displayed on the display screen 11 of the user terminal 10B owned by the woman F2, as illustrated in FIG. 4A. In addition, for example, in a case of purchasing a product, the woman F2 taps the product image on the display screen, and the display transitions to the settlement screen, or the like; in a case of comparing the product with other products, if the woman F2 taps “See more” on the screen, the display can transition to, for example, a state of displaying other product information, as illustrated in FIG. 4B. Incidentally, the information associated with the scanning of the user terminal 10B is transmitted directly to the information processing device 30C, and the information processing device 30C may make an acquisition request for information to the information processing device 30B, or use the same communication path as described above.

In this case, for example, the information processing device 30C does not only use the information of the product itself as the advertising information, and displays other related information, for example, an item, a comment from the user, or the like, which is acquired from the information processing device 30B, as a part of the advertising information, on the display screen 11 at the same time.

In addition, when displaying the stock information, the information processing device 30b allows the user to also check other colors and sizes, in addition to the inventory information indicating whether or not the stock is present in the neighborhood store, such as a group chain. In this case, it is desirable that the user terminal 10 acquires the position information of another store, and sorts the inventory display in order of the neighborhood stores, from the current position (can be estimated by @ID).

Incidentally, in a case where it is determined that the user terminal 10A does not allow the advertising display because the user is not walking, and the user terminal 10A is not registered as “friend” in the relationship information, the information processing device 30A may transmit only the MID of the user terminal 10A to a separate information processing device 30B other than the user terminal 10B. Accordingly, the information processing device 30C can display a recommendation screen (solicitation screen) for “friend” registration, on the user terminal 10A. In this case, since it is determined that “friend” is not registered by the determination of the information processing device 30A, a recommendation screen (solicitation screen) for “friend” registration may be displayed on the user terminal 10A, by the information processing device 30A.

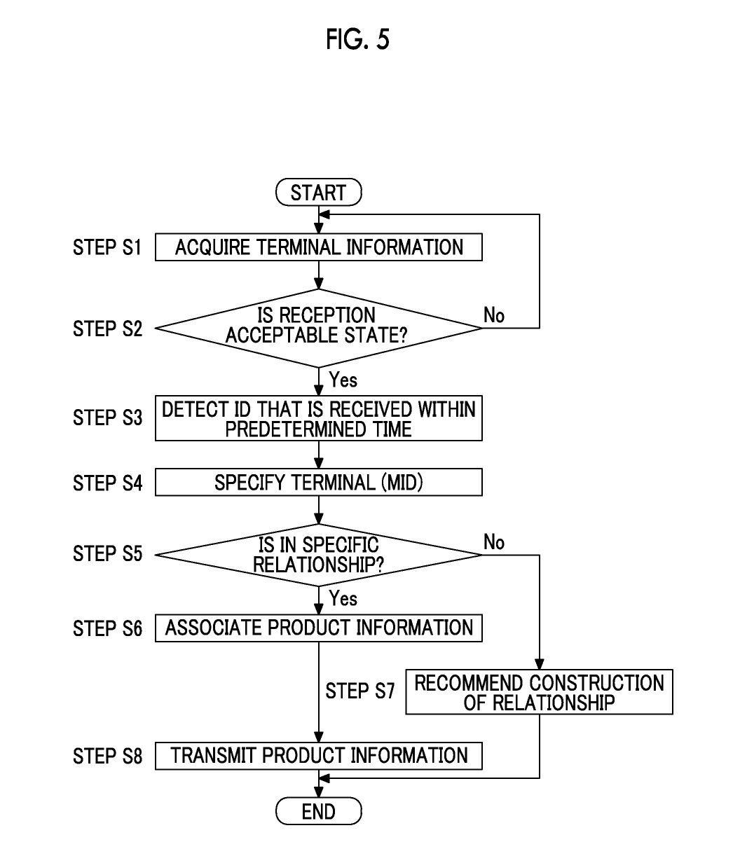

Next, the main routine of the determination circuit 38 according to the present invention will be described with reference to FIG. 5.

(Step S1)

In step S1, if the user terminal 10 receives a signal that has been transmitted by the information transmitting terminal 20, the determination circuit 38 receives the terminal information from the user terminal 10, and the process proceeds to step S2. Actually, the determination circuit 38 determines whether or not the terminal information is received in step S1; when the terminal information is received, this routine is executed; and otherwise, the determination circuit 38 enters a standby state until the terminal information is received.

In this case, the determination circuit 38 may be operated, for example, during the business hours of a store, or may be operated regardless of the business hours of the store. In this case, for example, the terminal information including the visitors in the store is received within the business hours, and the number of passers-by who stop and view the product that is displayed in the windows W1, W2 can be acquired outside of business hours.

Thus, by comparing the popularities (the degrees of interest) of the products which are displayed in the windows W1, W2 and those of the products that were displayed in the windows W1, W2 in the past. The displayed product can be replaced with other products, a study on a display method is repeated, and the number of visitors who will come again for purchasing a product during business hours can be estimated.

(Step S2)

In step S2, the determination circuit 38 determines whether or not the user terminal 10 that has sent the received terminal information is a user terminal that allows the display of the advertising information. In a case where it is determined that the user terminal 10 allows the display of the advertising information (Yes), the determination circuit 38 proceeds to step S3. In a case where it is determined that the user terminal 10 is not the user terminal that allows the display of the advertising information (No), the determination circuit 38 repeats the above routine by forming a loop together with step S1.

(Step S3)

In step S3, the determination circuit 38 proceeds to step S4, with a plurality of pieces of terminal information which are received within a predetermined time (for example, three seconds) as a group, from the timestamps of the terminal information that undergoes steps S1 and S2.

Since the determination circuit 38 sequentially receives the terminal information, each time, the terminal information pieces included within a predetermined time from the reception time (timestamp reference is possible) of the terminal information that has been received first are arranged in a group, and the subsequent information pieces may be handled as the next group. Thus, when only a single piece of terminal information is received until a predetermined time elapses from the first reception of the terminal information, the determination circuit 38 handles the single piece.

(Step S4)

In step S4, the determination circuit 38 specifies MID from one or more pieces of terminal information that are received, and proceeds to step S5.

In this case, if there are a plurality of pieces of terminal information forming a group in step S3, priorities are given in the time order of the timestamps, in descending order of the strength level of the reception strength, or in a predetermined order, and it is possible to perform the process of step S5 and the subsequent steps in descending order of priority.

In addition, in a case where the MID of the same user terminal 10 is included in the plurality of pieces of terminal information forming a group, for example, if product IDs are the same, it is possible not to perform a process of slowing the timestamp.

(Step S5)

In step S5, the determination circuit 38 determines whether or not the user terminal 10 is in a specific relationship. In other words, the determination circuit 38 determines whether or not there is information that is registered as “friend” among the relationship information pieces included in the terminal information. In a case where it is determined that there is information that is registered as “friend” in the terminal information (Yes), the determination circuit 38 proceeds to step S6. In a case where it is not determined that there is information that is registered as “friend” in the terminal information (No), the determination circuit 38 proceeds to step S7.

(Step S6)

In step S6, the determination circuit 38 acquires product information based on the product ID and @ID, by referring to a database, and proceeds to step S8.

(Step S7)

In step S7, since it is not determined that there is information that is registered as “friend” in the terminal information, the determination circuit 38 ends this routine by transmitting information to recommend a “friend” registration to the MID.

(Step S8)

In step S8, the determination circuit 38 ends this routine by transmitting advertising information to the user terminal 10 which is determined that there is information registered as “friend” in the terminal information.

Incidentally, the routine of steps S7 and S8 may be performed only on one piece of terminal information included in the group, or may be performed sequentially in order of priority on terminal information pieces which are orderly arranged. Further, if there is a different group in a time-series, it is assumed to repeat the same routine on the subsequent group.

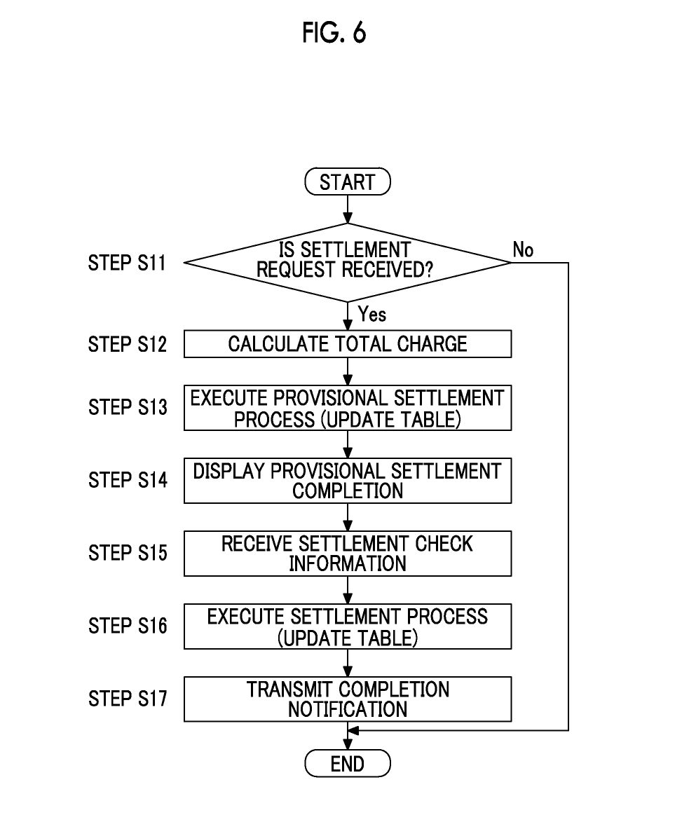

Next, a description will be made with reference to FIG. 6, regarding the settlement processing routine of the determination circuit 38 when the user performs a product purchase operation based on the advertising information displayed on the display screen 11 of the user terminal 10. Incidentally, the product purchase operation is the interrupt routine (or concurrent routine) for the main routine.

(Step S11)

In step S11, the determination circuit 38 determines whether or not there is a settlement request from the user terminal 10. In a case where it is determined that there is a settlement request from the user terminal (Yes), the determination circuit 38 proceeds to step S12. In a case where it is not determined that there is a settlement request from the user terminal 10 (No), the determination circuit 38 ends the routine.

In addition, the determination circuit 38 stops the screen display of, for example, the advertising screen (chat screen illustrated in FIGS. 4A and 4B), or performs an interrupt process, on the assumption that the user terminal 10 does not make a settlement request without monitoring this routine, in view of the case of purchasing a product in the store.

(Step S12)

In step S12, in a case where there are a plurality of products for which settlement is requested, the determination circuit 38 calculates the total amount of the purchased products, and proceeds to step S13.

Therefore, the determination circuit 38 does not calculate the total amount of money immediately after the user taps the screen display of one product, but calculates the total amount of money in response to a predetermined operation of the user, such as purchasing other products or issuing a total, similar to a well-known online purchasing service.

(Step S13)

In step S13, the determination circuit 38 executes a provisional settlement process, and proceeds to step S14. In addition, this temporary settlement includes, for example, the calculation or the like of the consumption tax, and presents the total amount to the purchaser. Thus, the table for all of the products that are purchased up to now is updated. It is assumed that the update of this table includes, for example, the update of the table of the database such as stock information, in addition to the update of the table about the settlement.

(Step S14)

In step S14, the determination circuit 38 displays (presents) the information about the completion of the provisional settlement on the display screen of the user terminal 10, and proceeds to step S15.

(Step S15)

In step S15, the user receives the consent of the provisional settlement using the user terminal 10, and the determination circuit 38 proceeds to step S16. In addition, the determination circuit 38 does not perform a countdown of a predetermined time by starting the timer or the like, for example, in consideration of a case where the user who saw the results of the provisional settlement operates the cancellation or the change of purchase. In addition, in a case where there are some operations performed by the user, for example, operations such as stop or change of purchasing, stop of the display of the chat screen, for example, the purchasing history (on the way) or the like may be left or may not be left in the memory circuit 33.

(Step S16)

In step S16, if the user consents to the provisional settlement, the determination circuit 38 executes the settlement process and updates the table of the state of the provisional settlement, and proceeds to step S17.

(Step S17)

In step S17, the determination circuit 38 transmits the fact that the settlement has been completed, or the advertising information including thanks for the purchase of a product or the like, to the user terminal 10, and ends the routine by displaying it on the display screen 11. In a case of the so-called online store purchase, instead of a store purchase, the number of days or the like until the product arrival (delivery, store receipt, or the like) is displayed.

Further, when performing an offline settlement, the settlement may also be performed by displaying a bar code or a two-dimensional code for each product, or it is also possible to display a bar code or a two-dimensional code by integrating the information in the cart. In this case, it is desirable that the target product can be confirmed by transmitting the purchase and settlement information to the store terminal.

If the settlement is completed, the determination circuit 38 performs control such that the same user (user terminal 10) cannot use the online settlement. Here, “cannot use” relates to the online settlement for additions and changes to the product that is already settled, and in the case of purchasing a new product, the online settlement may be executed based on a predetermined condition (for example, after the predetermined time has elapsed) from the beginning.

In addition, in a case where a product is purchased, or when the advertising information is displayed on the display screen 11, the addition such as recommendation of addition of “Friend” registration to the user by using the MID is arbitrary, for spread.

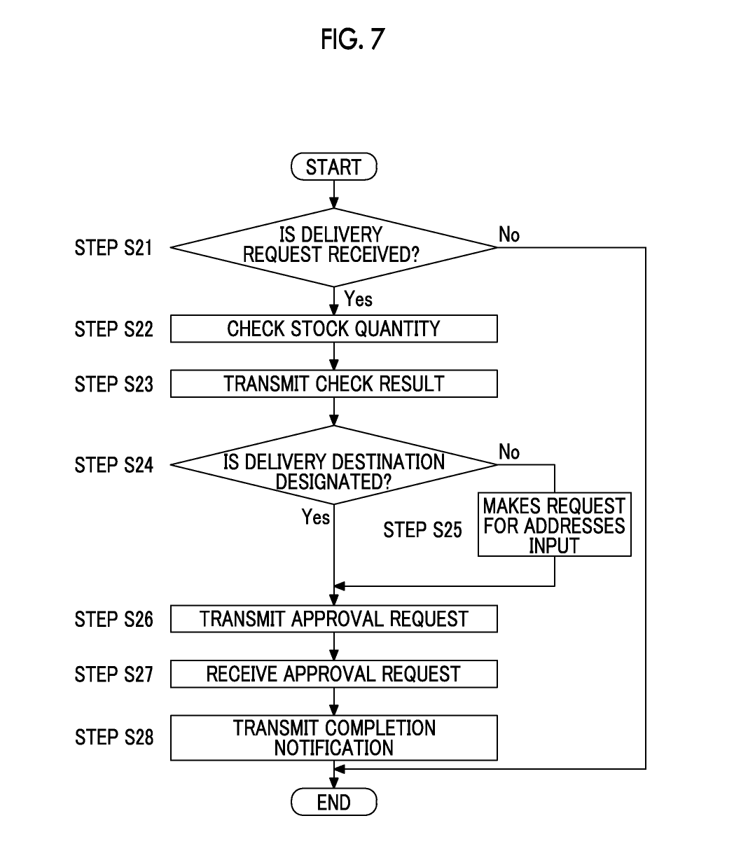

Next, the delivery processing routine of the determination circuit 38 in a case where the user performs the purchasing operation of a product based on the advertising information displayed on the display screen 11 of the user terminal 10 will be described based on FIG. 7. In addition, the product delivery operation is an interrupt routine for the product purchasing routine.

(Step S21)

In step S21, the determination circuit 38 determines whether or not there is a delivery request from the user terminal 10. In a case where it is determined that there is the delivery request from the user terminal (Yes), the determination circuit 38 proceeds to step S22. In a case where it is not determined that there is the delivery request from the user terminal 10 (No), the determination circuit 38 ends this routine.

(Step S22)

In step S22, the determination circuit 38 checks the stock quantity of the product for which transport is requested, and proceeds to step S23. In other words, here the product wanted by the user may not be limited to one, and may include different sizes and colors. In addition, in the case of chains, or the like, there is a case where a plurality of products are scattered in different stores or the like. Thus, the determination circuit 38 refers to the product database, and checks the stock status of the purchase scheduled product in real time.

(Step S23)

In step S23, the determination circuit 38 transmits the stock checked result including checking whether to continue the settlement or to deliver a product, to the user terminal 10 that wants to purchase a product, and proceeds to step S24.

(Step S24)

In step S24, the determination circuit 38 determines whether or not the destination of the product is designated. In other words, in a case of “friend” registration, the address and the like are stored in a database as the user information, but the delivery of the product is not limited to sending the product to the registered address, in a case of a present or the like. In addition, there is a case where the address is changed, or the address is not registered at the time of user registration. Therefore, in step S24, in consideration of these circumstances, in a case where there is address registration, whether or not delivery is destined to the registered address is determined. Since it is a product delivery to the registered address, in a case where it is determined that the delivery destination is designated (the designated address is in the database) (Yes), the determination circuit 38 proceeds to step S26. In a case where it is not determined that the delivery destination is designated (No), the determination circuit 38 proceeds to step S25.

(Step S25)

In step S25, the determination circuit 38 makes an input request for the delivery destination address to the user terminal 10, and proceeds to step S26 if there is a proper input of the address.

(Step S26)

In step S26, the determination circuit 38 transmits an approval request for confirmation of the delivery destination to the user terminal 10, and proceeds to step S27.

(Step S27)

In step S27, the determination circuit 38 receives the approval request for a delivery destination, and proceeds to step S28. In the case of a change in the delivery destination or the like, it is possible to loop to step S24.

(Step S28)

In step S28, the determination circuit 38 transmits a completion notification indicating that reception has been completed with respect to the delivery of the product, to the user terminal 10, and ends the routine.

In this manner, the determination circuit 38 according to the present embodiment controls the information processing device 30 that is connected to the user terminal 10 through the electric communication network NT, by a predetermined application which has been installed in advance in the user terminal 10 being started, if the user terminal 10 receives a signal transmitted from an information transmitting terminal 20.

In this case, if the advertising information is transmitted to the user terminal 10 caused by a predetermined application being installed in the user terminal 10, the determination circuit 38 can display the advertising information on the display screen 11 of the user terminal 10. In other words, the predetermined application is configured to receive a signal transmitted from the information transmitting terminal 20 through short-range wireless communication, and execute a function of displaying the advertising information or the like on the display screen 11 of the user terminal 10, based on the reception result.

In other words, since a predetermined application is in a state of transmitting advertising information and displaying it on the display screen 11, without selecting a store or a store type, the advertising information is transmitted without selecting the purchase target of a product, and inversely, this makes the user feel uncomfortable.

Therefore, the determination circuit 38 according to the present embodiment acquires a predetermined type of terminal information for determining whether or not the user terminal 10 includes preparation to receive advertising information corresponding to the signal transmitted from the information transmitting terminal 20, determines whether or not the terminal information includes preparation to receive advertising information, and transmits the advertising information to the user terminal 10 which is determined to include preparation to receive advertising information.

Thus, it is possible to provide an effective advertising information delivery service, including display of a more abundant amount of advertising information, by narrowing down users to a certain degree, such as suppressing the transmission of the advertising information to all of the user terminals 10 only by installing a predetermined application.

In addition, the sequence diagram illustrated in FIG. 3, and the flowcharts illustrated in FIG. 5, FIG. 6, FIG. 7, and the like are not intended to limit the procedure of the present invention, and it is possible to add and delete the procedure and change the order thereof, within a range without departing from the gist and technical idea of the invention.

For example, in the above embodiment, as illustrated in FIG. 3, the case is illustrated where the information processing device 30A that acquires the terminal information including the terminal state information transmitted from the user terminals 10A, 10B determines whether or not the display of the advertising information is allowed, but at least a part of the terminal state information may be determined by the user terminal 10.

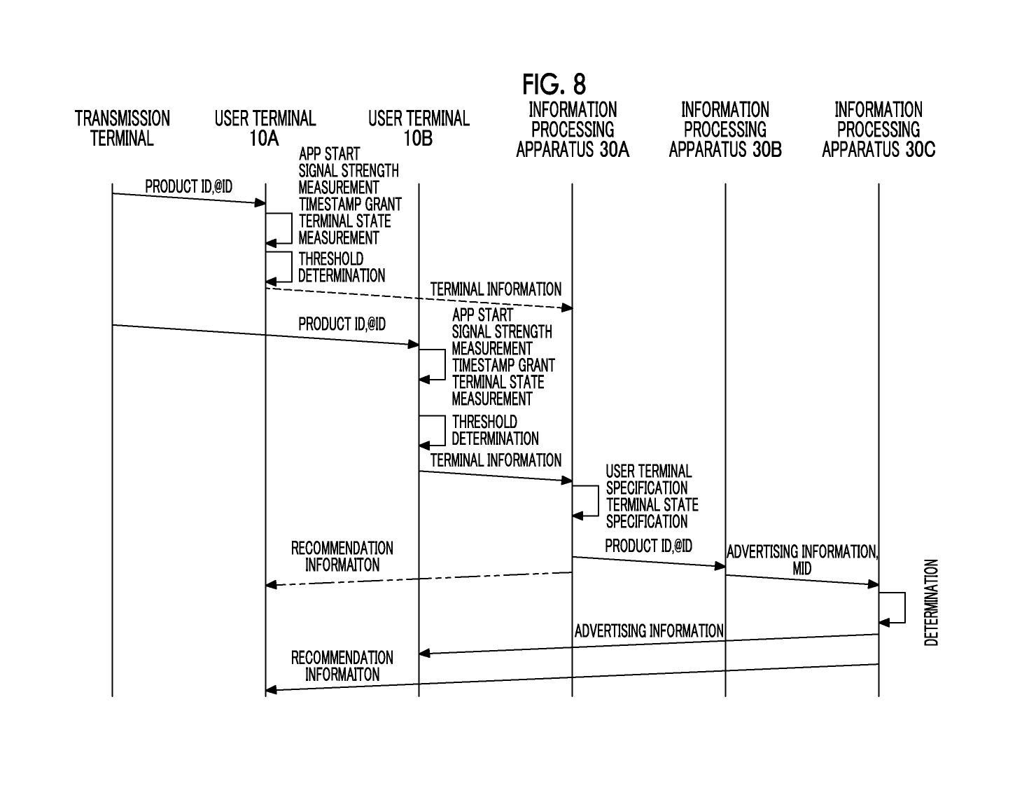

FIG. 8 illustrates a case where the CPUs of the user terminals 10A, 10B determine whether or not the reception wave strength of the terminal state information is a predetermined threshold or more, and control the transmission of the terminal information based on the determination result.

For example, the user terminal 10A executes the threshold determination as to whether the signal strength measurement result is a predetermined threshold or more which is set in advance. In a case where the signal strength measurement result is determined to be a predetermined threshold or more, the user terminal 10A transmits the product ID and @ID, and the terminal information including respective pieces of information regarding the application start, the signal strength measurement result (signal strength level), the timestamp grant, the terminal state measurement, and MID, to the information processing device 30A.

In the same manner, the user terminal 10B executes the threshold determination as to whether the signal strength measurement result is a predetermined threshold or more which is set in advance. In a case where the signal strength measurement result is a predetermined threshold or more, the user terminal 10B transmits the product ID and @ID, and the terminal information including respective pieces of information regarding the application start, the signal strength measurement result (signal strength level), the timestamp grant, the terminal state measurement, and MID, to the information processing device 30A.

In this case, for example, in a case where the signal strength measurement result is less than a predetermined threshold, the user terminal 10A does not transmit the terminal information to the information processing device 30A.

Therefore, the information processing device 30A specifies the user terminal 10B, and determines whether or not the user terminal 10B is in a state of allowing the display of the advertising information including other pieces of terminal state information in addition to the signal strength. Then, the information processing device 30A transmits, at least, the product ID, @ID, and the MID of the user terminal 10B in association with each other, to the information processing device 30B.

Thus, in the same manner as the above, the advertising information is displayed on the display screen 11 of the user terminal 10B owned by the woman F2.

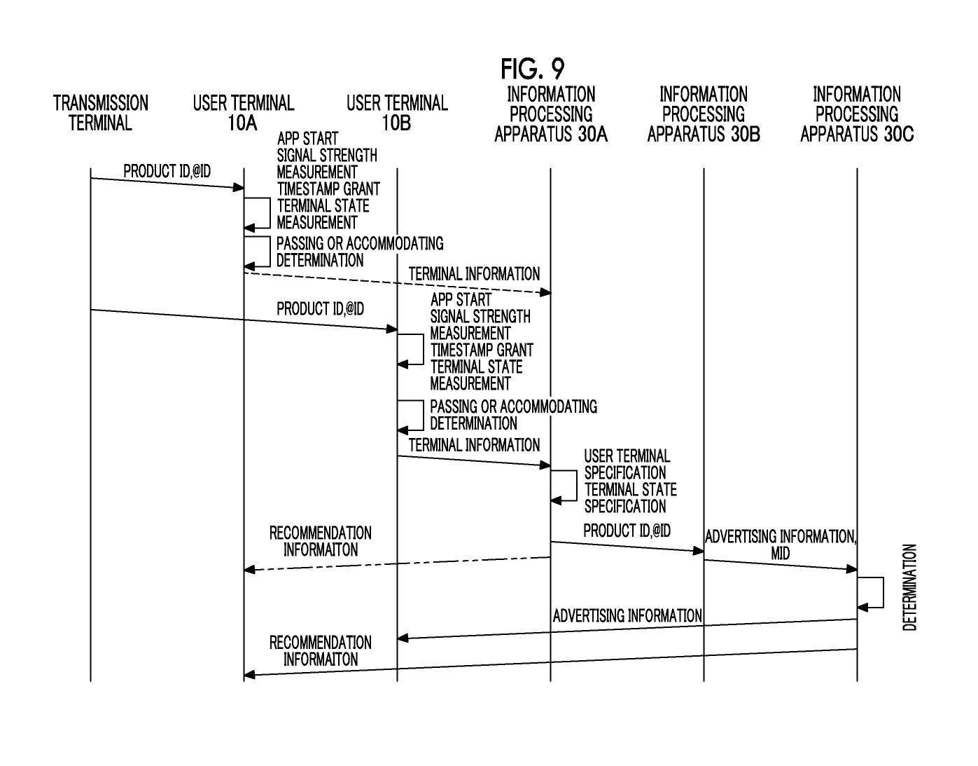

FIG. 9 illustrates the case where the CPU of the user terminal 10 determines whether or not the user terminal 10 is being moved (passed by) or being accommodated, based on terminal state information, and the transmission of the terminal information is determined based on the determination result.

For example, the user terminal 10A performs a passing or accommodating determination as to whether the moving is caused by the user's (woman F1) passing through the front of the store. In a case where it is not determined as “is moving”, the user terminal 10A transmits the product ID and @ID, and the terminal information including respective pieces of information regarding the application start, the signal strength measurement result (signal strength level), the timestamp grant, the terminal state measurement, and MID, to the information processing device 30A.

In the same manner, the user terminal 10B performs a passing or accommodating determination as to whether the moving is caused by the user's (woman F2) passing through the front of the store. In a case where it is not determined as “is moving”, the user terminal 10B transmits the product ID and @ID, and the terminal information including respective pieces of information regarding the application start, the signal strength measurement result, the timestamp grant, the terminal state measurement, and MID, to the information processing device 30A.

In this case, for example, in a case where it is determined as “is moving”, the user terminal 10A does not transmit the terminal information to the information processing device 30A.

Therefore, the information processing device 30A specifies the user terminal 10B, and determines whether or not the user terminal 10B is in a state of allowing the display of the advertising information including other pieces of terminal state information other than walking (or being accommodating). Then, the information processing device 30A transmits, at least, the product ID, @ID, and the MID of the user terminal 10B in association with each other, to the information processing device 30B.

Thus, similar to the above, the advertising information is displayed on the display screen 11 of the user terminal 10B owned by the woman F2.

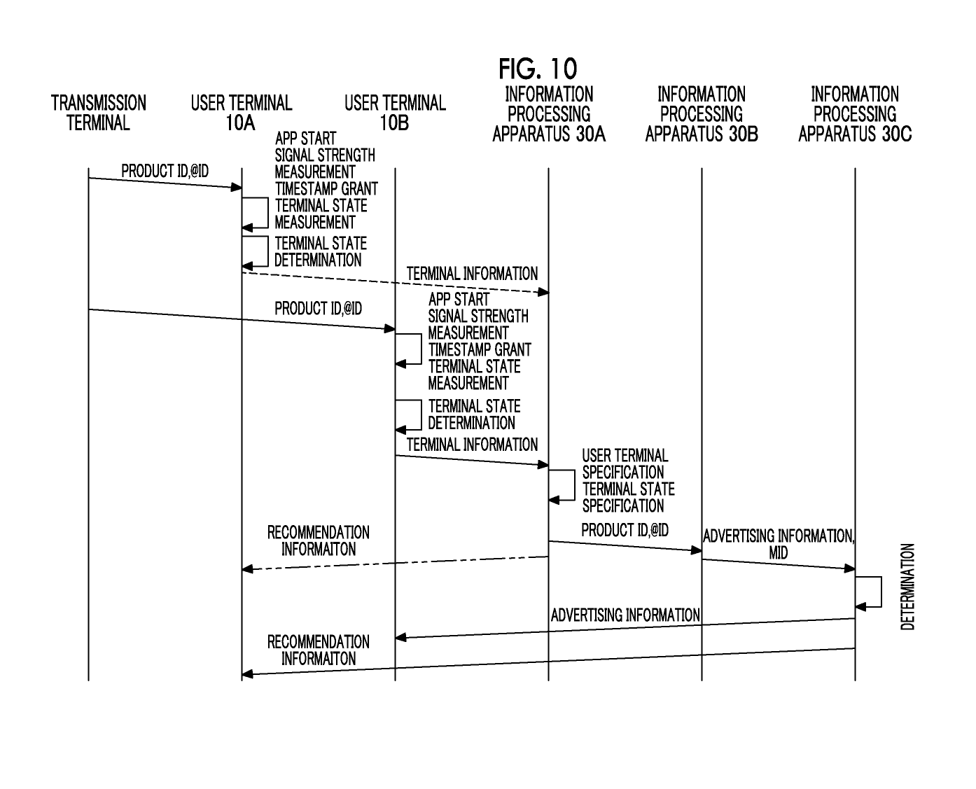

FIG. 10 illustrates a case where the CPU of the user terminal 10 determines all pieces of terminal state information, and if there is one negative determination, it is controlled such that the terminal information is not transmitted to the information processing device 30A.

For example, the user terminal 10A performs a threshold determination as to whether or not the signal strength measurement result is a predetermined threshold or more that is set in advance, a passing or accommodating determination as to whether the moving is caused by the user's (woman F1) passing through the front of the store, and a communication state determination as to whether or not the communication function such as the message display function is in use. In a case where all of them are positive, the user terminal 10A transmits the product ID and @ID, and the terminal information including respective pieces of information regarding the application start, the signal strength measurement result (signal strength level), the timestamp grant, the terminal state measurement, and MID, to the information processing device 30A.

In the same manner, the user terminal 10B performs a threshold determination as to whether or not the signal strength measurement result is a predetermined threshold or more that is set in advance, a passing or accommodating determination as to whether the moving is caused by the user's (woman F2) passing through the front of the store, and a communication state determination as to whether or not the communication function such as the message display function is in use. In a case where all of them are positive, the user terminal 10B transmits the product ID and @ID, and the terminal information including respective pieces of information regarding the application start, the signal strength measurement result (signal strength level), the timestamp grant, the terminal state measurement, and MID, to the information processing device 30A.

In this case, for example, if there is one negative determination, the user terminal 10A does not transmit the terminal information to the information processing device 30A.

Thus, similar to the above, the advertising information is displayed on the display screen 11 of the user terminal 10B owned by the woman F2.

In addition to those described previously, approaches according to the embodiment may be utilized in combination as appropriate.

For example, in the above-mentioned embodiment, the information transmitting terminal 20 of the present invention is for external use for transmitting a signal towards the sidewalk, but a plurality of them may be provided in the inside of the store, and may be targeted for customers who visit the store, in particular, a customer who views one product and the like.

Specifically, terminal information includes time information indicating a time when the user terminal 10 receives a signal transmitted from the information transmitting terminal 20. When a plurality of pieces of terminal information are acquired, the determination circuit 38 determines whether or not the same terminal information (MID) is acquired a plurality of times within a predetermined time, based on the time information pieces. When it is determined that the same MID is acquired the plurality of times within a predetermined time, the determination circuit 38 may transmit advertising information to the user terminal 10 with the MID.

Thus, it is possible to transmit the advertising information to the woman F2 illustrated in FIG. 1, for example, outdoors. Further, it is possible to transmit the advertising information about the sample which is selected, to customers who visit the store, especially to customers who stop and select products in the inside of a store. Here, even if there are a plurality of customers in the vicinity, it is possible to transmit the advertising information to a customer who is as close as possible to the product, due to different information transmitting terminals 20, or different reception strengths. In addition, in the inside of the store, for example, the advertising information may be transmitted to the customers when the switch or the like is pressed, or an RFID or the like may also be used.

As described above, the control method for an information processing device according to the present invention has an effect capable of improving the convenience of a service, while reducing a possibility of giving discomfort and a feeling of dislike, by determining whether or not the user wants the display of advertising information or does not want the display thereof based on a predetermined condition, in addition to the installation of the predetermined application, and is applicable to the entirety of information processing devices which are to be connected to a user terminal through an electric communication network, by a predetermined application which is installed in advance in the user terminal being started, if the user terminal receives a signal transmitted from an information transmitting terminal.

What is claimed is:

1. A control method for an information processing device which is to be connected to a user terminal through an electric communication network, by a predetermined application which is installed in advance in the user terminal being started, if the user terminal receives a signal transmitted from an information transmitting terminal, the control method comprising:
acquiring a predetermined type of terminal information for determining whether or not the user terminal includes preparation to receive advertising information corresponding to the signal transmitted from the information transmitting terminal, in addition to the installation of the predetermined application in the user terminal;
determining whether or not the terminal information includes preparation to receive advertising information; and
transmitting the advertising information to the user terminal which transmits the terminal information which is determined to include preparation to receive the advertising information in the determining.

2. The control method for an information processing device according to claim 1,
wherein the terminal information includes time information and signal reception strength information when the user terminal receives the signal transmitted from the information transmitting terminal,
wherein the determining further includes
determining whether or not the time information is within a predetermined time, when the terminal information is acquired from a plurality of the user terminals, and
specifying the user terminal having a highest reception strength level of the reception strength information, among all of the user terminals for which the time information is determined to be within the predetermined time in the terminal reception time determining, and
wherein in the advertising information transmitting, the advertising information is transmitted to the user terminal that is specified in the terminal specifying.

3. The control method for an information processing device according to claim 1,
wherein the terminal information includes terminal state information for specifying whether or not the user terminal when receiving the signal transmitted from the information transmitting terminal is in a predetermined reception acceptable state due to an action of a user for preparation to receive the advertising information,
wherein the determining further includes specifying whether or not the terminal state information is in a predetermined reception acceptable state when the terminal information is acquired from the user terminal, and
wherein in the advertising information transmitting, the advertising information is transmitted to the user terminal for which it is specified that the terminal state information is in a predetermined reception acceptable state in the terminal state specifying.

4. The control method for an information processing device according to claim 1,
wherein the terminal information includes
time information and signal reception strength information when the user terminal receives the signal transmitted from the information transmitting terminal, and
terminal state information for specifying whether or not the user terminal when receiving the signal transmitted from the information transmitting terminal is in a predetermined reception acceptable state due to an action of a user for the preparation to receive the advertising information,
wherein the determining further includes
determining whether or not the time information is within a predetermined time, when the terminal information is acquired from a plurality of the user terminals,
specifying the user terminals in descending order of the reception strength level of the reception strength information, among all of the user terminals for which the time information is determined to be within a predetermined time in the terminal reception time determining, and
specifying whether or not the terminal state information is in a predetermined reception acceptable state, in descending order of the reception strength level of the reception strength information that is specified in the terminal specifying, and
wherein in the advertising information transmitting, the advertising information is transmitted to the user terminal for which it is specified that the terminal state information is in a predetermined reception acceptable state in the terminal state specifying.

5. The control method for an information processing device according to claim 1,
wherein the terminal information includes function information indicating that a message display function is included in the predetermined application which is installed in the user terminal, and relationship information for starting the message display function in association with the signal transmitted from the information transmitting terminal,
wherein the determining includes determining whether or not the relationship information is included, when the terminal information is acquired from the user terminal, and
wherein in the advertising information transmitting, if it is determined that the relationship information is included in the terminal information in the mutual friendship determining, the advertising information is transmitted to the user terminal so as to start the message display function.

6. The control method for an information processing device according to claim 1,
wherein the predetermined application including a message display function is installed in the user terminal,
wherein the terminal information includes
time information and signal reception strength information when the user terminal receives the signal transmitted from the information transmitting terminal, and
relationship information for starting the message display function in association with the signal transmitted from the information transmitting terminal,
wherein the determining further includes
determining whether or not the time information is within a predetermined time, when the terminal information is acquired from a plurality of the user terminals,
specifying the user terminals in descending order of the reception strength level of the reception strength information, among all of the user terminals for which the time information is determined to be within a predetermined time in the terminal reception time determining, and
determining whether or not the relationship information is included, in descending order of the reception strength level of the reception strength information which is specified in the terminal specifying, and
wherein in the advertising information transmitting, if it is determined that the relationship information is included in the terminal information in the mutual friendship determining, the advertising information is transmitted to the user terminal so as to start the message display function.

7. The control method for an information processing device according to claim 1,
wherein the predetermined application including a message display function is installed in the user terminal,
wherein the terminal information includes
terminal state information for specifying whether or not the user terminal when receiving the signal transmitted from the information transmitting terminal is in a predetermined reception acceptable state due to an action of the user for preparation to receive the advertising information,
time information and signal reception strength information when the user terminal receives the signal transmitted from the information transmitting terminal, and
relationship information for starting the message display function in association with the signal transmitted from the information transmitting terminal,
wherein the determining further includes
specifying whether or not the terminal state information is in a predetermined reception acceptable state, when the terminal information is acquired from the user terminal,
determining whether or not the time information that is acquired from the plurality of user terminals is within a predetermined time, in a case where there are a plurality of user terminals which are specified that the terminal state information is in a predetermined reception acceptable state in the terminal state specifying,
specifying the user terminals in descending order of the reception strength level of the reception strength information, among all of the user terminals for which the time information is determined to be within a predetermined time in the terminal reception time determining, and
determining whether or not the relationship information is included, in descending order of the reception strength level of the reception strength information which is specified in the terminal specifying, and
wherein in the advertising information transmitting, if it is determined that the relationship information is included in the terminal information in the mutual friendship determining, the advertising information is transmitted to the user terminal so as to start the message display function.

8. The control method for an information processing device according to claim 1,
wherein the terminal information includes time information when the user terminal receives the signal transmitted from the information transmitting terminal,
wherein the determining further includes determining whether or not the same terminal information is acquired a plurality of times within a predetermined time, based on the time information, when a plurality of pieces of terminal information are acquired, and
wherein in the advertising information transmitting, the advertising information is transmitted to the user terminal which transmits the same terminal information for which it is determined that the same terminal information is acquired a plurality of times within a predetermined time in the same terminal determining.

9. An information processing device which is to be connected to a user terminal through an electric communication network, by a predetermined application which is installed in advance in the user terminal being started, if the user terminal receives a signal transmitted from an information transmitting terminal, the information processing device comprising:
a terminal information acquisition circuit that acquires a predetermined type of terminal information for determining whether or not the user terminal includes preparation to receive advertising information corresponding to the signal transmitted from the information transmitting terminal, in addition to the installation of the predetermined application in the user terminal;
a determination circuit that determines whether or not the terminal information includes preparation to receive advertising information;
an advertising information transmission circuit that transmits the advertising information to the user terminal which transmits the terminal information which is determined to include preparation to receive advertising information by the determination circuit.

10. A non-transitory computer readable recording medium having a control program stored thereon, the program causing a computer which is to be connected to a user terminal through an electric communication network, by a predetermined application which is installed in advance in the user terminal being started, if the user terminal receives a signal transmitted from an information transmitting terminal,
wherein the program causes the computer to realize the following functions of:
acquiring a predetermined type of terminal information for determining whether or not the user terminal includes preparation to receive advertising information corresponding to the signal transmitted from the information transmitting terminal, in addition to the installation of the predetermined application in the user terminal;
determining whether or not the terminal information includes preparation to receive advertising information; and
transmitting the advertising information to the user terminal which transmits the terminal information which is determined to include preparation to receive advertising information in the determination function.
